(19) United States
(12) Patent Application Publication
(10) Pub. No.: US 2025/0378606 A1
(43) Pub. Date: Dec. 11, 2025

(54) IMAGE PROCESSING METHOD AND APPARATUS, DEVICE, AND STORAGE MEDIUM

(71) Applicant: Beijing Zitiao Network Technology Co., Ltd., Beijing (CN)

(72) Inventors: Xiaohui ZHANG, Beijing (CN); Guanjun GUO, Beijing (CN)

(21) Appl. No.: 18/877,962

(22) PCT Filed: Aug. 18, 2023
(86) PCT No.: PCT/CN2023/113661

§ 371 Date: Dec. 20, 2024

(30) Foreign Application Priority Data
Sep. 9, 2022 (CN) 202211105419.4

(51) Int. Cl. G06T 11/60

(52) U.S. Cl. CPC G06T 11/60

(57) ABSTRACT

Disclosed herein are an image processing method and apparatus, an electronic device and a storage medium. The method includes: obtaining an image (S110); receiving a template triggering operation for the image and displaying at least one template each comprising at least one template element (S120); and receiving a template selection operation for the template, and displaying a target effect image by applying a selected template to the image, wherein a target display mode of at least part of template elements is different from a default display mode of the at least part of the template elements (S130).

The present disclosure claims the priority from the Chinese patent application No. 202211105419.4 filed with the China National Intellectual Property Administration (CNIPA) on Sep. 9, 2022, the disclosure of which is hereby incorporated by reference in its entirety.

### FIELD

The present disclosure relates to the technical field of computer technology, in particular, to an image processing method and apparatus, an electronic device, and a storage medium.

### BACKGROUND

With the ongoing advancement of internet and image processing technologies, numerous image processing methods have emerged. Users are increasingly drawn to image templates because of their appealing aesthetics, ease of use, and diverse options. As a result, more people are utilizing these templates to create a wider range of image effects.

In automated cover creation schemes, it's common to use a cover template. Typically, a creator designs the layout of the title and stickers based on a specific cover draft. However, since users may upload a wide range of cover drafts, applying an old template layout to new designs can result in unsatisfactory outcomes, such as the title and stickers obscuring important parts of the image, ultimately leading to subpar visual effects.

### SUMMARY

The embodiments of the present disclosure provide an image processing method and apparatus, an electronic device, and a storage medium, to enhance the visual effect of images and improve the user experience.

In a first aspect, the present disclosure provides an image processing method, comprising: obtaining an image; receiving a template triggering operation for the image and displaying at least one template each comprising at least one template element; and receiving a template selection operation for the template, and displaying a target effect image by applying a selected template to the image, wherein a target display mode of at least part of template elements is different from a default display mode of the at least part of the template elements.

In a second aspect, the present disclosure provides an image processing apparatus, comprising: an image obtaining module configured to obtain an image; a template displaying module configured to receive a template triggering operation for the image, and display at least one template each comprising at least one template element; and an image displaying module configured to receive a template selection operation for the template, and display a target effect image by applying a selected template to the image, wherein a target display mode of at least part of the template elements is different from a default display mode of the at least part of the template elements.

In a third aspect, the present disclosure provides an electronic device, comprising: one or more processors; and a memory configured to store one or more programs; wherein the one or more programs, when executed by the one or more processors, cause the one or more processors to implement the image processing method described above.

In a fourth aspect, the present disclosure provides a storage medium comprising computer executable instructions used to execute the image processing method described above when executed by a computer processor.

In a fifth aspect, the present disclosure provides a computer program product comprising a computer program carried on a non-transitory computer readable medium, wherein the computer program comprises program codes for executing the image processing method described above.

### BRIEF DESCRIPTION OF THE DRAWINGS

FIG. 1 illustrates a flowchart of an image processing method provided by embodiments of the present disclosure;

FIG. 2 illustrates a flowchart of another image processing method provided by embodiments of the present disclosure;

FIG. 3 illustrates a flowchart of a further image processing method provided by embodiments of the present disclosure;

FIG. 4 illustrates a flowchart of a still further image processing method provided by embodiments of the present disclosure;

FIG. 5 illustrates a flowchart of a still further image processing method provided by embodiments of the present disclosure;

FIG. 6 illustrates an overall flowchart of an image processing method provided by embodiments of the present disclosure;

FIG. 7 illustrates a schematic diagram of a structure of an image processing apparatus provided by embodiments of the present disclosure; and

FIG. 8 illustrates a schematic diagram of a structure of an electronic device provided by embodiments of the present disclosure.

### DETAILED DESCRIPTION OF EMBODIMENTS

Reference now will be made to the drawings to describe the embodiments of the present disclosure. Although some embodiments of the present disclosure are depicted in the drawings for an understanding of the present disclosure, the present disclosure could be implemented in various forms. The drawings and embodiments of the present disclosure are provided herein only as examples.

The respective steps in the implementations of the method according to the present disclosure may be performed in different orders and/or performed in parallel. In addition, the method implementations may include additional steps and/or steps omitted. The scope of the present disclosure is not limited in the aspect.

As used herein, the term “includes” and its variants are to be read as open-ended terms that mean “includes, but is not limited to.” The term “based on” is to be read as “based at least in part on.” The term “an embodiment” is to be read as “at least one embodiment;” the term “another embodiment” is to be read as “at least one further embodiment;” the term “some embodiments” is to be read as “at least some embodiments.” Related definitions of other terms will be provided in the description below.

It should be noted that, the terms “first,” “second,” and the like mentioned in the present disclosure are only used to distinguish different apparatuses, modules or units, rather than limit an order of functions performed by the apparatus, module or unit or limit interdependence.

It should be noted that, the terms “a,” “an,” and “a plurality of” mentioned in the present disclosure are illustrative, not restrictive, and should be understood as “one or more” by those skilled in the art, unless explicitly specified otherwise in the context.

Names of messages or information interacted between a plurality of apparatuses in the embodiments of the present disclosure are illustrative rather than limit the scope of the messages or information.

Prior to applying the technical solution according to various embodiments of the present disclosure, the user should be informed of the type, scope of use, and use scenario of the personal information involved in an appropriate manner, and user authorization should be obtained.

For example, in response to receiving an active request from a user, prompt information is sent to the user to explicitly inform the user that the requested operation would acquire and use the user's personal information. Therefore, according to the prompt information, the user may decide on his/her own whether to provide the personal information to software or hardware, such as electronic devices, applications, servers or storage media that perform operations of the technical solution of the present disclosure.

As an optional implementation, in response to receiving an active request from a user, the method of sending prompt information to the user may, for example, include a pop-up window, where the prompt information may be presented in the form of text in the pop-up window. In addition, the pop-up window may also carry a select control for the user to choose to “agree” or “disagree” to provide the personal information to the electronic device.

The above process of notifying and obtaining the user authorization is only illustrative, and other methods compliant with the provisions of the relevant laws and regulations can also be applied to the implementations of the present disclosure.

The data (including data per se, and acquisition or application of the data) involved in the present technical solution should comply with the provisions of the corresponding laws and regulations as well as relevant stipulations.

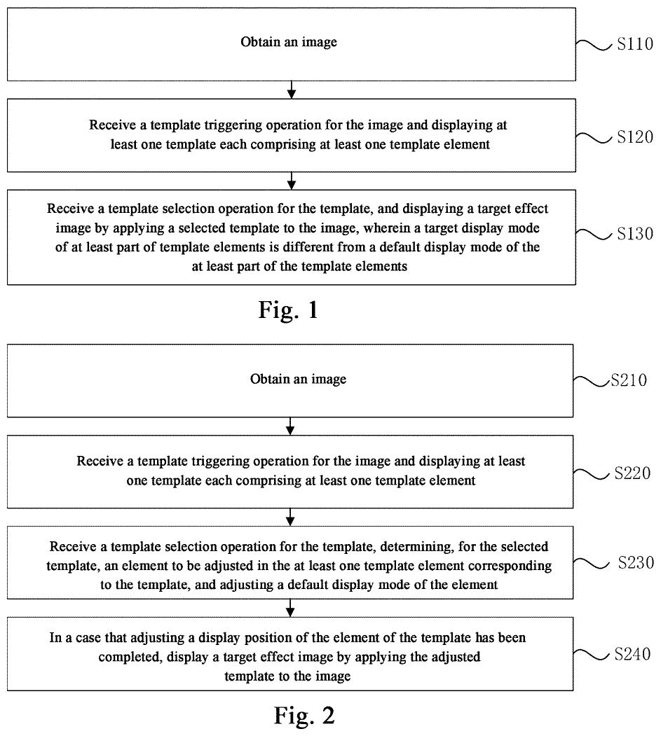

FIG. 1 is a flowchart of an image processing method provided by embodiments of the present disclosure. The embodiments of the present disclosure can be applied to a scenario of beautifying images. The method can be performed by an image processing apparatus, which can be implemented in the form of software and/or hardware, or by an electronic device that may be a mobile terminal, a Personal Computer (PC) or server, or the like.

As shown therein, the method according to embodiments of the present disclosure includes: S110: obtaining an image to be processed.

The image may be an image having not undergone the template processing. In the embodiments of the present disclosure, the content of the image is not limited. The image may be a subject image, an environment image, or the like. For example, the image may be a selfie, an animal image, a food image, a scenery image, or the like.

In response to an image-obtaining triggering operation, the image is obtained.

The image-obtaining triggering operation may be a triggering operation for obtaining the image. In the embodiments of the present disclosure, the image-obtaining triggering operation may be performed in various forms, which may be, for example, triggering a preset image obtaining control for obtaining the image, receiving a preset image obtaining sound or gesture, or the like. The image obtaining control may be a virtual control preset on an application interface, or may be a physical key. The image obtaining control may be a camera control for capturing images in real time, or may be an upload control for uploading images, or the like. The image-obtaining triggering operation can be preset according to the application scenario, which is not limited herein.

By way of example, the image-obtaining triggering operation may be clicking a button of “upload image,” or “camera,” swiping left/right on the screen, issuing an “image obtaining” sound, or the like, to obtain the image.

Obtaining the image in response to the image-obtaining triggering operation includes: in response to an image-adding triggering operation, displaying at least one added original image; and receiving an image selection operation for at least one original image, and using the selected image as the image.

The image-adding triggering operation may be a trigger operation for adding the original image. In the embodiments of the present disclosure, the image-adding triggering operation may be performed in various forms, which may be, for example, triggering a preset control for adding the original image, performing a preset sound or gesture, or the like. The image-adding triggering operation can be preset according to the application scenario, for example, as clicking a button of “add image”, swiping left/right on the screen, issuing a sound of “add image,” to add the original image, which is not limited specifically herein.

In the embodiments of the present disclosure, the type of the original image is not limited. The original image may be a subject image, an environment image, or the like. For example, the original image may be a selfie, an animal image, a food image, a scenery image, or the like.

The image selection operation may be a selection operation for at least one added original image, and the selected image is used as the image to be processed. In the embodiments of the present disclosure, the image selection operation may include selecting one or more images from the added original images. The image selection operation can be preset according to the application scenario, for example, as clicking one or more images in the added original images, which is not specifically limited herein.

The method further includes: S120: receiving a template triggering operation for the image and displaying at least one template each comprising at least one template element.

In the embodiments of the present disclosure, in order to guarantee the overall presenting effect of the template, each template element may be configured with a corresponding default display by applying it to the image.

The template triggering operation may be a triggering operation for viewing the template. In the embodiments of the present disclosure, the template triggering operation may be performed in various forms, which may be triggering a preset control for displaying the template, receiving a preset template triggering sound or template triggering gesture, or the like. The template triggering operation can be preset according to the application scenario, for example, as clicking a template identifier button for viewing a template, to display the template, which is not limited specifically herein. Wherein, the template identifier button can be set on an image presenting interface for displaying the image.

The template may be a template available to users. In the embodiments of the present disclosure, the template pattern may be preset according to the scenario requirement, which is not limited herein. By way of example, the template may be a girl wearing blush, a travel diary, or the like. For example, in the case that the image is a selfie, the target effect of applying the template of a girl wearing blush to the image may include displaying a person with blush on his/her face; or in the case that the image is a scenery image, the target effect of applying the travel diary to the image may include displaying a text sticker of “holiday,” or the like, on the basis of the default display mode corresponding to the image.

The template element may be an element for forming a template, which can be displayed on the image. The template may be a text, a sticker, a picture, or the like. By way of example, the template element may be a pattern sticker of “blush,” a text or pattern sticker of “croissant sandwich,” or the like. In the embodiments of the present disclosure, a template may include therein one or more template elements. Different templates may contain the same template element, or different template elements.

In the embodiments of the present disclosure, a default display mode of each template element in the template can be preset, to guarantee the overall presenting effect of the template. The default display mode may be a preset display position of the template element in the template. The default display mode includes at least one type of display information such as a default display position, a default posture, a default display size, a default display color, and the like.

A click operation of clicking template identifier(s) arranged on the image display interface of the image is received, to display the template identifier(s) of one or more templates available to the users. The template identifier may be a thumbnail of an example effect image of applying the template to the sample image, to enable the users to view the image effect resulting from applying the template.

The method further includes: S130: receiving a template selection operation for the template, and displaying a target effect image by applying a selected template to the image, wherein a target display mode of at least part of template elements is different from a default display mode of the at least part of the template elements.

The template selection operation may be an operation for selecting the template. In the embodiments of the present disclosure, the template selection operation may be performed in various forms, which may be, for example, an operation of triggering one of the at least one displayed template. The template selection operation may include an operation of selecting a template, an operation of cancelling the selected template, and an operation of determining the selected template. For example, clicking a template indicates selecting the template; clicking the template again or clicking the button of “Cancel” indicates deselecting the template; double-clicking the template or clicking the button of “Confirm” indicates determining the selected template as the target template.

The target effect image may be an effect image obtained by applying the template to the image.

The target display mode may be a display position of the template element on the image. In the embodiments of the present disclosure, the default display mode and the target display mode (i.e., the display position of the template element in the template and the display position thereof on the image) may be the same, or may be different. In the case that the display position of the template element in the target effect image is the target display mode, more satisfactory target effect image can be attained.

In the embodiments of the present disclosure, the selected template may be applied to the entire area of the image, or may be applied to a partial area of the image. The entire area, or the partial area, of the image can be displayed in the target effect image.

The area to be displayed in the image is determined, and the selected template is then applied to the area to obtain the target effect image. Displaying the target effect image by applying the adjusted template to the image may include: determining a target display area in the image; determining a target image based on the target display area; and displaying the target effect image by applying the selected template to the target image.

The target display area may be an area of the image to be displayed in the target effect image. The target display area may be the entire display area, or a partial display area, of the image.

In the embodiments of the present disclosure, for each template, a base image size (i.e., a template size) matching the template can be preset. The template size can be set according to the actual scenario need, which is not limited herein. By way of example, the template size may be 512*512, 256*256, 256*512, or the like. The size of the image and the size of the selected template may be the same, or may be different. Therefore, the target display area in the image is determined based on the size of the image.

By way of example, in the case that the size of the image is equal to, or less than, the size of the selected template, the target display area may be the entire display area of the image; in the case that the size of the image is greater than the size of the selected template, the target display area may be a partial display area of the image.

Determining the target display area in the image may include at least one of the following operations: determining salient information in the image, and using an image area corresponding to the salient information as the target display area; determining an environmental target subject in the image, and using an image area corresponding to the environmental target subject as the target display area; or determining, based on a second model, the target display area in the image.

The salient information may be outstanding information in the image. The salient information may be salient or prominent subject information in a subject image. By way of example, the salient information may be a person in a selfie, and an area of the selfie where the person is located may be used as the target display area.

The salient information in the image is determined based on a pre-trained salient-information extraction model. Wherein, the salient-information extraction model can be trained based on sample images and salient information labels corresponding to the sample images, which may be, for example, a machine learning model, a deep learning model, a neural network model, or the like. The salient information labels can be obtained by labeling, by users, the sample images as actually required.

The environmental target subject may be an environmental subject of the user's interest in the information of the image. The environmental target subject may be an environmental object corresponding to a preset subject type in the image. By way of example, the environmental target subject may be a plant, a building, or the like, in the image. The environmental target subject may be a person, or the like, in the image. In this way, it can be guaranteed not to miss the image information of the user's interest for display.

The second model may be a detection model for detecting a target display area agreeing to aesthetic features in the image. By way of example, the second model can be trained based on aesthetic sample images and expected output images corresponding to the aesthetic sample images, where a sample aesthetic area is labeled in each expected output image. The aesthetic sample image may be a sample image for training the second model, for example, a selfie, an animal image, an environment image, a scenery image, and/or the like. The expected output image may be an aesthetic image that the second model is expected to output, where a sample aesthetic area expected to be labeled by the second model (e.g. an area with an added template element to beautify the aesthetic sample) is labeled.

By training the second model based on the aesthetic sample images and the expected output images corresponding to the aesthetic sample images, the trained second model is obtained, and the image is then input into the trained second model to determine a target display area corresponding to the image.

Determining, based on the target display area, a target image includes: cropping the image based on the target display area, to obtain an image area including the target display area as the target image.

The technical solution according to embodiments of the present disclosure includes: obtaining an image, enabling a subjective selection for the image, which demonstrates the universality of the template; receiving a template triggering operation for the image and displaying at least one template each comprising at least one template element and configured with a default display mode by applying it to the image, displaying the template for user's selection and supporting personalized processing of the image; receiving a template selection operation for the template, and displaying a target effect image by applying a selected template to the image, where a target display mode of at least part of template elements is different from a default display mode of the at least part of the template elements. With the aesthetics-based layout tuning solution, the layout of the template can be tuned finely for the content of the image, to enhance the match degree of the selected template with an image, beautify the target effect image, achieve a harmonious layout effect, and thus improve the user experience.

FIG. 2 illustrates a flowchart of another image processing method provided by embodiments of the present disclosure. Those embodiments provide further description of “displaying a target effect image by applying a selected template to the image” mentioned in the above embodiments.

As shown therein, the method according to the embodiments of the present disclosure may include:
S210: obtaining an image;
S220: receiving a template triggering operation for the image and displaying at least one template each comprising at least one template element; and
S230: receiving a template selection operation for the template, determining, for the selected template, an element to be adjusted in the at least one template element corresponding to the template, and adjusting a default display mode of the element.

Considering that the template may match the image to a great extent, upon detecting that the template meets a preset adjustment condition, an element to be adjusted in the at least one template element corresponding to the template is determined. The preset adjustment condition may be a preset condition for detecting whether the template needs to be adjusted, for example, a condition for detecting whether the template matches the image or not. The element may be a template element for which the display mode needs to be adjusted in the process of processing the image based on the template.

The preset adjustment condition may be, in a case that the image includes a target interactive subject, whether the template element is displayed with the target interactive subject in a preset interactive mode, or whether the template element is located in an interactive display area corresponding to the target interactive subject. Wherein, the interactive display area may be an expected display area of a template element corresponding to the target interactive subject.

For example, if the template is “a girl with blush,” the target interactive subject corresponding to the “blush” in the image may be a facial area of a person or an animal. If the “blush” is not displayed in the facial area, the “blush” may be regarded as the element to be adjusted.

The preset adjustment condition may be whether there is an overlap between the template element and a further template element, and/or between the template element and the environmental target subject of the image. If there is an overlap between the template element and the further template element, and/or between the template element and the environmental target subject of the image, the template element may be regarded as the element to be adjusted.

The preset adjustment condition may be whether the template element is located in the target display area in the image. If the template element is not located in the target display area of the image, the template element may be regarded as the element to be adjusted.

Adjusting the default display mode of the element may include: adjusting the display mode of the element from the default display mode to the target display mode, for example, adjusting, based on an element category corresponding to each element in the template and an adjustment priority corresponding to the element category, the default display mode of the element.

The element categories may be referred to as the classifications of the template elements. The element categories may include an interactive element, a title element, or others. The others may be elements other than the interactive element and the title element.

The element categories of the template elements may be classified as actually required, which is not limited herein. For ease of application, an element category corresponding to each template element may be pre-labeled when the template is designed.

The interactive element may be an element that needs to interact with the image, to determine the target display mode. The interactive element may be a text or pattern sticker, or the like, displayed on the target interactive subject through interaction with the target interactive subject. By way of example, the interactive element may be a sticker of “crown” displayed on the head of the target interactive subject, a sticker of “blush” displayed on the face of the target interactive subject, or the like.

The title element may be an element labeling the template theme. By way of example, the title element may be a holiday theme element, a food theme element, or the like. The title element may be a text/sticker of “holiday,” a text/sticker of “croissant sandwich,” or the like.

The adjustment priorities may be an adjustment order corresponding to the element categories when the elements are adjusted. In general, a higher adjustment priority corresponding to the element category indicates that the adjustment is performed at an earlier time, i.e., the element is adjusted earlier. In the embodiments of the present disclosure, adjustment priorities corresponding to the element categories, from high to low, are as follows: the interactive element, the title element, and others.

S240: in a case that adjusting a display position of the element of the template has been completed, displaying a target effect image by applying the adjusted template to the image.

For the image, the display positions of the interactive element, the title element, and others in the template are adjusted according to the preset adjustment priorities, and in the case that the adjustment has been completed, the adjusted template is applied to the image, to thus obtain and then display a target effect image.

The technical solution according to the embodiments of the present disclosure includes: for the selected template, determining an element in at least one template element corresponding to the template, and adjusting a default display mode of the element; according to the preset adjustment priorities, adjusting the template elements in a preset order; in the case that adjusting the display position of the element of the template has been completed, displaying a target effect image by applying the adjusted template to the image, to thus achieve a harmonious layout effect for the target effect image.

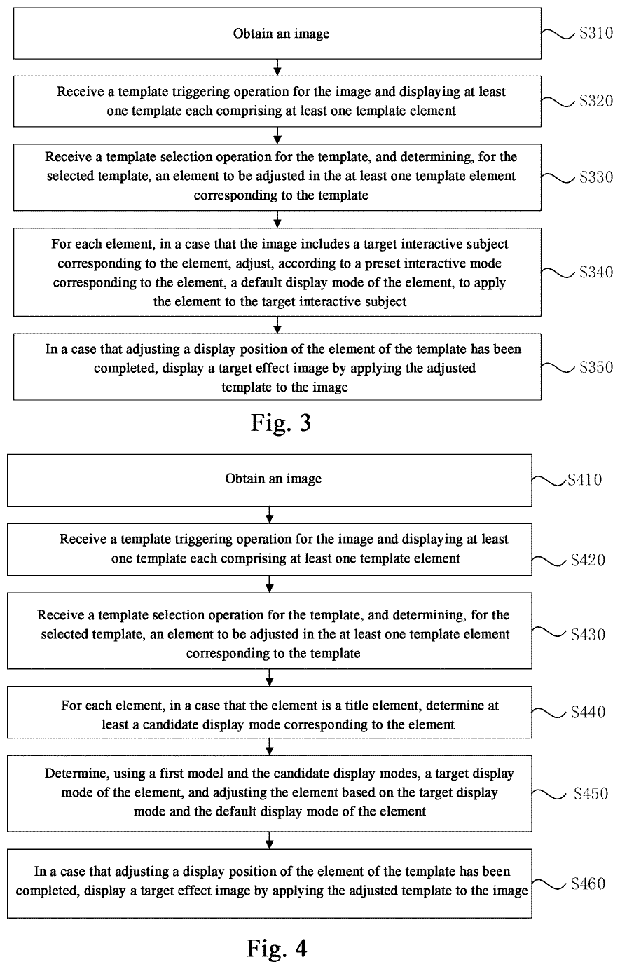

FIG. 3 illustrates a flowchart of a further image processing method provided by embodiments of the present disclosure. These embodiments provide further description of “adjusting a default display mode of the element” mentioned in the above embodiments.

As shown therein, the method according to the embodiments of the present disclosure may include:
S310: obtaining an image.
S320: receiving a template triggering operation for the image and displaying at least one template each comprising at least one template element.
S330: receiving a template selection operation for the template, and for the selected template, determining an element to be adjusted in the at least one template element corresponding to the template.
S340: for each element, in a case that the image includes a target interactive subject corresponding to the element, adjusting, according to a preset interactive mode corresponding to the element, a default display mode of the element, to apply the element to the target interactive subject.

The target interactive subject may be a subject that can interact with the interactive element. The preset interactive mode may be a preset interactive mode between the element and the corresponding target interactive subject. The preset interactive mode may be a preset mode for determining the display of the element in the target display area corresponding to the target interactive subject.

By way of example, in the case that the image is a selfie and the template is “a girl with blush,” the element may be a sticker of “blush,” and the target interactive subject may be a face of a person in the selfie, where the preset interactive mode may be displaying the sticker of “blush” in the cheek area of the person's face.

Adjusting the default display mode of the element according to a preset interactive element corresponding to the element may include: determining, based on element key point information of the element and area key point information of the target display area corresponding to the target interactive subject, an adjustment mode of the element, and adjusting the element according to the adjustment mode. The adjustment mode includes adjusting a movement direction, a movement distance, a posture, and the like.

S350; in a case that adjusting a display position of the element of the template has been completed, displaying a target effect image by applying the adjusted template to the image.

If the image includes a target interactive subject corresponding to the element, the default display mode of the interactive element can be adjusted according to the preset interactive mode, to apply the interactive element to the target interactive subject in the target interactive mode, to thus obtain and then display a target effect image.

The technical solution according to the embodiments of the present disclosure includes: for each element to be adjusted, in a case that the image includes a target interactive subject corresponding to the element, adjusting a default display mode of the element according to a preset interactive mode corresponding to the element, to apply the element to the target interactive subject. In this way, the relative position of the interactive element on the image can be determined, to cause the template element to match the image to a greater extent and thus beautify the target effect image.

FIG. 4 illustrates a flowchart of a still further image processing method provided by embodiments of the present disclosure. These embodiments provide further description of “adjusting a default display mode of the element” mentioned in the above embodiments.

As shown therein, the method according to embodiments of the present disclosure may include:
S410: obtaining an image.
S420: receiving a template triggering operation for the image and displaying at least one template each comprising at least one template element.
S430: receiving a template selection operation for the template, and determining, for the selected template, an element to be adjusted in the at least one template element corresponding to the template.
S440: for each element, in a case that the element is a title element, determining at least a candidate display mode corresponding to the element.

The candidate display mode may be available display information when the title element is displayed in the image. The candidate display mode at least includes a candidate display position and a candidate display posture. Wherein, the candidate display position may be a candidate display position of the title element. There may be one or more candidate display positions of the title element in the image. The candidate display posture may be a candidate display posture of the title element, which may be a default display posture, a display posture by rotating the default display posture a preset angle, or a display posture by stretching the default display posture.

There may be one or more candidate display modes of the title element. In the case of a plurality of candidate display modes of the title element, it is required to determine the target display mode.

At least one candidate display mode corresponding to the element can be determined based on image subject information in the image. Wherein, the image subject information includes a subject display area and a subject display posture. By way of example, a candidate display position corresponding to the element can be determined based on an image area in the image, other than the subject display area where the image subject is located. Then, the display posture of the title element can be determined based on the image subject posture of the image subject in the image.

S450: determining, using a first model and the candidate display modes, a target display mode of the element, and adjusting the element based on the target display mode and the default display mode of the element.

The first model may be a model for scoring a plurality of candidate display modes. The first model can be trained based on sample scored images and expected scores corresponding to the sample scored images.

The sample scored image may be a sample image for training the first model. The sample scored image may be a selfie, an animal image, an environment image, a scenery image, and/or the like. The expected score may be a labeled score expected to be output by the first model for the sample scored image. The score output by the first model may be a normalized aesthetic score. By way of example, the expected score may be 0.2, 0.6, 0.9, or the like.

In the embodiments of the present disclosure, the scoring results may be results output by scoring the candidate display modes through the trained first model, and a candidate display mode suitable for acting as the target display mode can be determined based on the scoring results. The target display mode may include a target display position and a target display posture.

In the embodiments of the present disclosure, different candidate display modes can be scored by the pre-trained first model, to determine the target display mode.

By way of example, the candidate display modes can be divided into five aesthetic levels based on the scoring results output by the first model. The aesthetic level of the candidate display mode with a scoring result falling within the range of [0, 0.2] is labeled as the first aesthetic level, the aesthetic level of the candidate display mode with a scoring result falling within the range of [0.2, 0.4] is labeled as the second aesthetic level, the aesthetic level of the candidate display mode with a scoring result falling within the range of [0.4, 0.6] is labeled as the third aesthetic level, the aesthetic level of the candidate display mode with a scoring result falling within the range of [0.4, 0.6] is labeled as the fourth aesthetic level, and the aesthetic level of the candidate display mode with a scoring result falling within the range of [0.8, 1] is labeled as the fifth aesthetic level, where the fifth aesthetic level is the optimal aesthetic level.

The candidate display mode corresponding to the output optimal aesthetic level is used as the target display mode, or the candidate display mode with the output aesthetic level higher than a preset aesthetic level is used as the target display mode.

There may be one or more candidate display modes corresponding to the aesthetic level of the target display mode. In the case of a candidate display mode corresponding to the aesthetic level, the candidate display mode can be used as a target display mode; in the case of a plurality of candidate display modes corresponding to the aesthetic level, a candidate display mode selected randomly through a random algorithm is used as the target display mode.

The first model is trained based on sample scored images and expected scores corresponding to the sample scored images; the plurality of candidate display modes is then input into the trained first mode to output corresponding scoring results; the scoring results are divided into five scoring levels; and the candidate display mode corresponding to the highest aesthetic level is used as the target display mode.

S460: in a case that adjusting a display position of the element of the template has been completed, displaying a target effect image by applying the adjusted template to the image.

The target display mode of the title element is determined based on the scoring results, and the display position and the display posture of the title element are adjusted based on the target display mode, to apply the title element to the image in the target display mode to thus obtain and then display a target effect image.

The technical solution according to the embodiments of the present disclosure includes: for each element to be adjusted which is a title element, determining at least a candidate display mode corresponding to the element, where the display candidate mode includes a candidate display position and a candidate display posture, and the plurality of candidate display modes may provide a filtering basis for determining the target display mode of the element; scoring, by a pre-trained first model, the candidate display modes; determining, based on scoring results, a target display mode of the element; adjusting the element according to the target display mode and the default display mode of the element, where the first model is trained based on sample scored images and expected scores corresponding to the sample scored images. By applying the trained first model, the relative position of the title element on the image is determined, to thus enable a harmonious layout of template elements in the target effect image and beautify the effect.

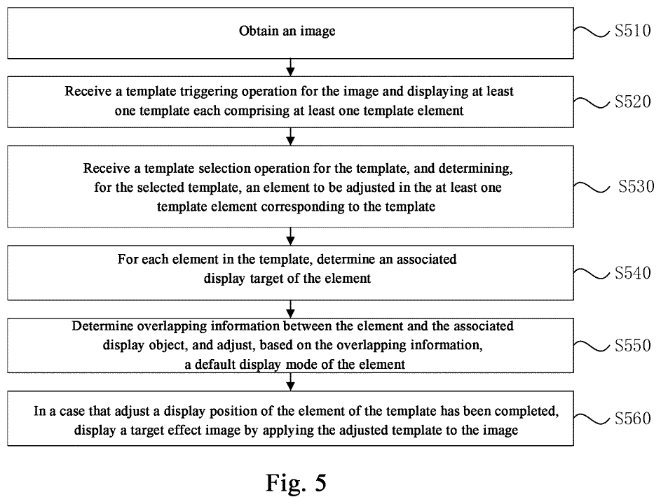

FIG. 5 illustrates a flowchart of a still further image processing method provided by embodiments of the present disclosure. These embodiments provide further description of “adjusting a default display mode of the element” mentioned in the above embodiments.

As shown therein, the method according to the embodiments of the present disclosure may include:
S510: obtaining an image.
S520: receiving a template triggering operation for the image and displaying at least one template each comprising at least one template element.
S530: receiving a template selection operation for the template, and determining, for the selected template, an element to be adjusted in the at least one template element corresponding to the template.
S540: for each element, determining an associated display object of the element.

The associated display object may be a display object associated with the display mode of the element. The associated display object may be a display object that may overlap the element during display. The associated display object may be salient information in the image, a scenery target subject in the image, or other template elements in the template.

As described above, in the embodiments of the present disclosure, adjustment priorities may be set for different categories of template elements. For example, adjustment priorities corresponding to the element categories, from high to low, are as follows: the interactive element, the title element, and others. In these embodiments, the element may be other element than the interactive element and the title element.

S550: determining overlapping information between the element and the associated display object, and adjusting, based on the overlapping information, a default display mode of the element.

The overlapping information may be position information on an overlap between the element and the associated display object.

Determining overlapping information between the element and the associated display object includes: obtaining contour information or a mask image of the element, and determining, based on the contour information or the mask image, whether there is an overlapping area between the element and the associated display object.

The contour information may be edge information of a visualization area when the element is displayed on the image, i.e., a visible contour of the element. The contour information of the element is pre-labeled. Alternatively, the contour information of the element is identified using an edge detection algorithm or a pre-trained contour detection model.

In the embodiments of the present disclosure, the element may be in the form of a sticker. In the sticker of the element, other areas than the visualization area may be set to be transparent. The mask image may include a binary image generated for the visualization area and the transparent area of the element to highlight the visualization area of the element.

The overlapping information may be that there is an overlapping area, or there is no overlapping area. Based on the obtained contour information or mask image of the element, whether there is an overlapping area between the element and the associated display object is determined. The overlapping area may be the one between the visualization area of the element and the associated display object.

In a case that there is no overlapping area between the template element and the associated display object, the template element is not the element to be adjusted, for which no adjustment is needed.

In the embodiments of the present disclosure, the objective of adjusting the default display mode of the element is to cause the overlapping area between the element and the associated display object to disappear.

Adjusting the default display mode of the element to cause the overlapping area between the element and the associated display object to disappear includes: in the case that there is an overlapping area between the element and the associated display object, adjusting the default mode of the element to cause the overlapping area between the element and the associated display object to disappear.

There may be one or more elements overlapping the associated display object. In the embodiments of the present disclosure, in the case of a plurality of elements associated with the associated display object, the default display positions of the elements may be adjusted in different ways, such that the elements having no overlapping area with the associated display object have different display modes.

Adjusting the default display mode of the element to cause the overlapping area between the element and the associated display object to disappear includes: determining, based on display positions of the element and the associated display object, a first direction vector, and adjusting, based on the first direction vector, the default display mode of the element to cause the overlapping area between the element and the associated display object to disappear.

The display positions may be those of the visualization areas of the element and the associated display area in the target effect image.

The first direction vector may be a direction from a midpoint of the associated display object to a midpoint of the element.

Adjusting, based on the first direction vector, the default display mode of the element includes: moving the element from the default display position along the first direction vector; or in a case of two or more associated display objects each having an overlapping area with the element, determining, based on at least two of the first direction vectors corresponding to the associated display objects, a second direction vector, and moving the element from the default display position along the second direction vector.

There may be one or more of the associated display objects overlapping the element. In a case of an associated display object overlapping the element, the element is moved from the default display position along the first direction vector, to adjust the display position of the element. In a case of a plurality of the associated display objects overlapping the element, a second direction vector is determined based on at least two of the first direction vectors, and the element is then moved along the second direction vector, to adjust the display position of the element.

Determining the second direction vector based on at least two of the first direction vectors corresponding to the associated display objects may include computing, for each associated display object, an overlap degree corresponding to an Intersection over Union (IoU) of the element and the associated display object, and using the overlap degree corresponding to the IoU as a weight of the first direction vector corresponding to the associated display object, the first direction vector is weighted (i.e., the first direction vector is multiplied by the weight). Thereafter, the plurality of weighted first direction vectors are summed up, to obtain the second direction vector. In the case of two or more of the associated display objects each having an overlapping area with the element, by determining the second direction vector, the element can be adjusted quickly, to cause the overlapping areas between the element and the associated display objects to disappear, and thus improve the efficiency of adjusting the element.

S560: in a case that adjusting a display position of the element of the template has been completed, displaying a target effect image by applying the adjusted template to the image.

In the case that there is an overlapping area between the element and the associated display object, the first or the second direction vector is determined, the elements, other than the interactive element and the title element, are moved in the first or the second direction vector, to cause the overlapping area between the element and the associated display area to disappear, and thus obtain and then display a target effect image.

The technical solution according to the embodiments of present disclosure include: for each element to be adjusted, determining an associated display object of the element, to determine an object for which overlapping information needs to be detected; determining overlapping information between the element and the associated display object; and adjusting, based on the overlapping information, a default display mode of the element. By determining the first or the second direction vector, the technical solution can simply and efficiently cause the overlapping area between the element and the associated display object to disappear (i.e., the obtained target effect image contains no image overlap), to beautify the target effect image.

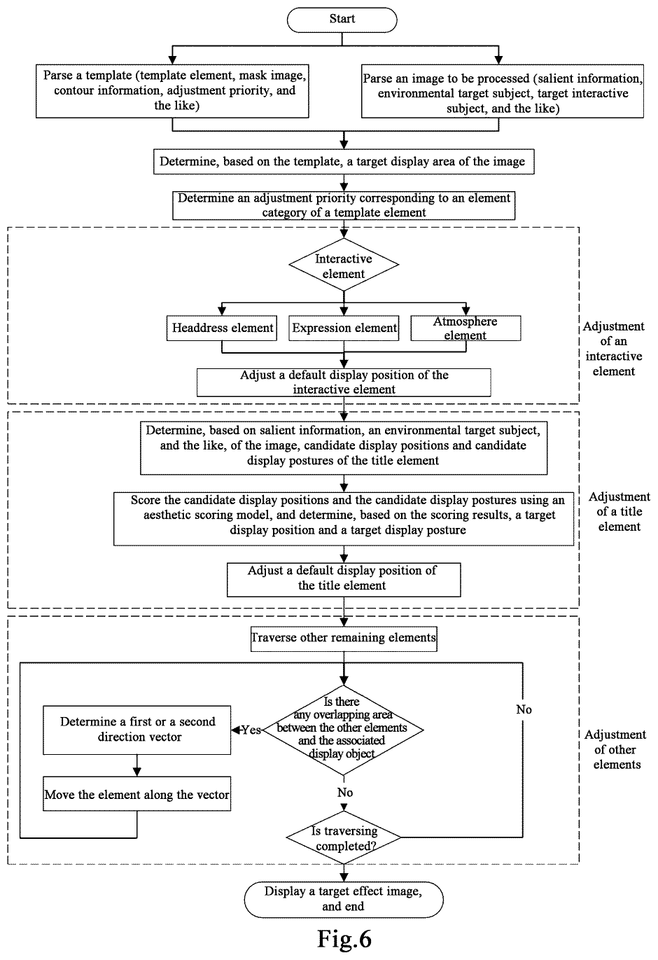

FIG. 6 illustrates an overall flow of an image processing method provided by embodiments of the present disclosure. As shown therein, in the embodiments of the present disclosure, the image processing may include steps of: parsing a template; parsing an image; determining a target display area in the image; dividing template elements of the template into a plurality of categories, and determining adjustment priorities corresponding to the categories of the template elements; and displaying a target effect image.

1. Parsing a template. Information on each template element pre-labeled or pre-stored in the template, such as a mask image, contour information, an element type, an adjustment priority, and the like, is obtained. Wherein, adjustment priorities corresponding to the element categories, from high to low, are as follows: the interactive element, the title element, and others.

2. Parsing an image. The image is parsed, to obtain image information of interest in the image, such as salient information, an environmental target subject, a target interactive subject, and the like, for use in the target display area in the image.

3. Determining the target display area in the image. The size of the template is identified, and parameters of the image, such as an offset, a scaling factor, a rotation angle, and the like, are adjusted to display the target display area in the base image layer of the template (i.e., to display the target display area in the target effect image).

4. Dividing the template elements of the template into a plurality of element categories, and determining adjustment priorities corresponding to the element categories. In the embodiments of the present disclosure, the adjustment priority of the template element under an element category agrees to the adjustment priority of the element category. If there is a plurality of template elements under an element category, the template elements can be traversed and adjusted in a preset order.

5. Adjusting the template elements according to the adjustment priorities corresponding to the element categories.
1) Interactive element

The default display mode of the interactive element is adjusted according to a preset interactive mode corresponding to the interactive element, to apply the interactive element to the target interactive subject.
2) Title element

Candidate display positions and candidate display postures of the title element are determined based on salient information, an environmental target subject, and the like, of the image; a first model (e.g. an aesthetic scoring mode) is used to score the candidate display positions and the candidate display postures; the target display position and the target display posture of the title element are determined based on the scoring results; and then, the default display mode of the title element is adjusted based on the target display positions and the target display postures.
3) Elements other than the interactive element and the title element.

If there is no overlapping area between the template element and the associated display object, element adjustment can be ended, and the template is then applied to the image, to obtain a target effect image.

If there is an overlapping area between the template element and the associated display object, a corresponding first or second direction vector is determined, and other elements are moved along the vector until the overlap disappears.

6. Displaying a target effect image.

The technical solution according to the embodiments of the present disclosure includes: for an image template application scenario, intelligently understanding a content of a base image; automatically tuning, based on the content of the base image and according to an aesthetic rule, a layout of a title and template elements such as a sticker, or the like, in the image template. With the technical solution, a better aesthetic outcome can be attained after the template is fused with a new base image, and a pleasant, harmonious layout effect can be achieved without manual adjustment after the user selected an image template, which can save time and effort while improving the user experience.

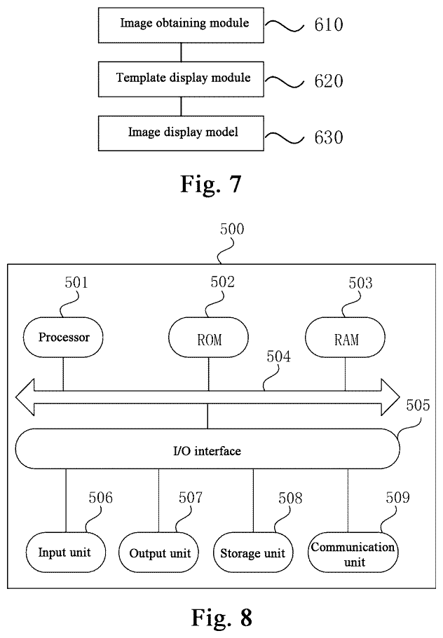

FIG. 7 illustrates a schematic diagram of a structure of an image processing apparatus provided by embodiments of the present disclosure. As shown therein, the apparatus includes: an image obtaining module 610, a template displaying module 620, and an image displaying module 630.

The image obtaining module 610 is configured to obtain an image; the template displaying module 620 is configured to receive a template triggering operation for the image, and display at least one template each comprising at least one template element; and the image displaying module 630 is configured to receive a template selection operation for the template, and display a target effect image by applying a selected template to the image, wherein a target display mode of at least part of the template elements is different from a default display mode of the at least part of the template elements.

The technical solution according to embodiments of the present disclosure includes: obtaining an image, enabling a subjective selection for the image, which demonstrates the universality of the template; receiving a template triggering operation for the image and displaying at least one template each comprising at least one template element, enabling a subjective selection for a template and improving the personalized image processing; receiving a template selection operation for the template, and displaying a target effect image by applying a selected template to the image, where a target display mode of at least part of template elements is different from a default display mode of the at least part of the template elements. With the aesthetics-based layout tuning solution, the layout of the template can be tuned finely for the content of the image, to beautify target effect images and achieve a harmonious layout effect, and thus improve the user experience.

The image display module 630 includes: an element position adjustment sub-module, and a target effect image displaying sub-module.

The element position adjustment sub-module is configured, for the selected template, to determine an element of the at least one template element corresponding to the template, and adjusting a default display mode of the element; and the target effect image displaying sub-module is configured, in a case that a display position of the element of the template has been adjusted, to display the target effect image by applying the adjusted template to the image.

The element position adjustment sub-module is configured to:
for each element, in a case that the image comprises a target interactive subject corresponding to the element, adjust the default display mode of the element according to a preset interactive mode corresponding to the element to apply the element to the target interactive subject.

The element position adjustment sub-module is configured to:
for each element, in a case that the element is a title element, determine at least one set of candidate display modes corresponding to the element; and determine, using a first model and the candidate display modes, a target display mode of the element, and adjust the element based on the target display mode and the default display mode of the element.

The element position adjustment sub-module includes: an associated display object determining unit, and an overlapping information applying unit.

The associated display object determining unit is configured, for each element, to determine an associated display object of the element; and the overlapping information applying unit is configured to determine overlapping information between the element and the associated display object, and adjust, based on the overlapping information, the default display mode of the element.

The overlapping information applying unit is configured to:
obtain contour information or a mask image of the element, and determine, based on the contour information or the mask image, whether there is an overlapping area between the element and the associated display object.

The overlapping information applying unit includes: a display position adjustment sub-unit.

The display position adjustment sub-unit is configured, in a case that there is an overlapping area between the element and the associated display object, to adjust the default display mode of the element to cause the overlapping area between the element and the associated display object disappear. The display position adjustment sub-unit is configured to:
determine, based on display positions of the element and the associated display object, a first direction vector, and adjust, based on the first direction vector, the default display mode of the element to cause the overlapping area between the element and the associated display object disappear.

The element position adjustment sub-module is configured to:
adjust, based on an element category corresponding to each element in the template and an adjustment priority corresponding to the element category, the default display mode of the element.

Element categories comprise an interactive element, a title element or others, and wherein adjustment priorities corresponding to the element categories, from high to low, are as follows: the interactive element, the title element, and others.

The image display module 630 includes: a target display area determining sub-module.

The target display area determining sub-module is configured to determine a target display area in the image, determine, based on the target display area, a target image, and display the target effect image by applying the selected template to the target image.

The target display area determining sub-module is configured to perform at least one of the following operations:
determining salient information in the image, and using an image area corresponding to the salient information as the target display area; determining an environmental target subject in the image, and using an image area corresponding to the environmental target subject as the target display area; or determining, based on a second model, a target display area in the image.

The image processing apparatus provided by the embodiments of the present disclosure can perform the image processing method provided by any of the embodiments of the present disclosure, which includes functional blocks corresponding to the method and can achieve the corresponding effects.

A plurality of units and blocks included in the above-mentioned apparatus is divided according to the functional logic, which are not confined to the above division as long as they can implement the respective functions. In addition, names of the plurality of functional units are employed only for differentiation from one another, without suggesting any limitation to the protection scope of the embodiments of the present disclosure.

FIG. 8 illustrates a schematic diagram of a structure of an electronic device provided by embodiments of the present disclosure. Hereinafter, reference will be made to FIG. 8 that illustrates a schematic diagram of a structure of an electronic device (e.g. a terminal device or server in FIG. 8) 500 adapted to implement embodiments of the present disclosure. The terminal device according to the embodiments of the present disclosure may include a mobile terminal such as a mobile phone, a laptop computer, a digital broadcast receiver, a Personal Digital Assistant (PDA), a Portable Android Device (PAD), a Portable Media Player (PMP), an on-vehicle terminal (e.g. an on-vehicle navigation terminal) or the like, or a fixed terminal such as a digital television (TV), a desktop computer or the like. The electronic device 500 as shown in FIG. 8 is provided merely as an example, without suggesting any limitation to the functions and the application range of the embodiments of the present disclosure.

As shown therein, the electronic device 500 may include a processor (e.g. a central processor, a graphics processor or the like) 501, which can execute various acts and processing based on programs stored in a Read Only Memory (ROM) 502 or a program loaded from a storage unit 508 to a Random Access Memory (RAM) 503. RAM 503 stores therein various programs and data required for operations of the electronic device 500. The processor 501, the ROM 502 and the RAM 503 are connected to one another via a bus 504. An input/output (I/O) interface 505 is also connected to the bus 504.

Typically, the following units may be connected to the I/O interface 505: an input unit 506 including, for example, a touchscreen, a touch pad, a keyboard, a mouse, a camera, a microphone, an accelerometer, a gyroscope and the like; an output unit 507 including, for example, a Liquid Crystal Display (LCD), a loudspeaker, a vibrator and the like; a storage unit 508 including, for example, a tape, a hard drive and the like; and a communication unit 509. The communication unit 509 can allow wireless or wired communication of the electronic device 500 with other devices to exchange data. Although FIG. 8 shows the electronic device 500 including various units, it would be appreciated that not all of the units as shown are required to be implemented or provided. Alternatively, more or fewer units may be implemented or provided.

In particular, according to embodiments of the present disclosure, the processes described above with reference to the flowchart may be implemented as a computer software program. For example, embodiments of the present disclosure include a computer program product comprising computer programs carried on a non-transitory computer readable medium, the computer program containing program code for performing the method as shown in the flowchart. In those embodiments, the computer program may be downloaded and installed from a network via the communication unit 509, or may be installed from the storage unit 508, or may be installed from the ROM 502. The computer program, when executed by the processor 501, performs the above-described functions defined in the method according to the embodiments of the present disclosure.

Names of messages or information interacted between a plurality of apparatuses in the embodiments of the present disclosure are illustrative rather than limit the scope of the messages or information.

The electronic device provided by the embodiments of the present disclosure belongs to the same invention concept as the image processing method provided by the above-mentioned embodiments. For the technical details not exhausted here, see the above-mentioned embodiments, and these embodiments can achieve the same advantageous effect as the above-mentioned embodiments.

The embodiments of the present disclosure provide a computer storage medium having a computer program stored thereon, where the program, when executed by a processor, implements the video quality evaluation method provided by the above-mentioned embodiments.

The computer readable medium according to the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, an RAM, an ROM, an erasable programmable read-only memory (EPROM or flash memory), an optical fiber, a portable compact disc read-only memory (CD-ROM), an optical storage device, a magnetic storage device, or any suitable combination of the foregoing. In the present disclosure, a computer readable storage medium may be any tangible medium that can contain, or store, a program for use by or in connection with an instruction execution system, apparatus, or device. In contrast, in the present disclosure, a computer readable signal medium may include a propagated data signal with computer readable program code embodied therein, either in baseband or as part of a carrier wave. Such propagated data signal may take many forms, including, but not limited to, an electro-magnetic signal, an optical signal, or any suitable combination thereof. A computer readable signal medium may also be any computer readable medium that is not a computer readable storage medium and that can communicate, propagate, or transmit a program for use by or in connection with an instruction execution system, apparatus, or device.

Program code embodied on a computer readable medium may be transmitted using any appropriate medium, including but not limited to: electrical wires, optical cables, RF (radio frequency), etc., or any suitable combination of the foregoing.

In some embodiments, the client and the server may perform communication by using any known network protocol such as Hyper Text Transfer Protocol (HTTP) or any network protocol to be developed, and may connect with digital data in any form or carried in any medium (for example, a communication network). The communication network includes a local area network (LAN), a wide area network (WAN), an international network (for example, the internet), a peer-to-peer network (e.g. ad hoc peer-to-peer network), and any known network or network to be developed.

The computer-readable medium may be the one included in the electronic device, or may be provided separately, rather than assembled in the electronic device.

The computer-readable medium carries one or more programs which, when executed by the electronic device, cause the electronic device to: obtain an image; receive a template triggering operation for the image and displaying at least one template each comprising at least one template element; and receive a template selection operation for the template, and displaying a target effect image by applying a selected template to the image, wherein a target display mode of at least part of template elements is different from a default display mode of the at least part of the template elements.

Computer program code for performing operations of the present disclosure may be written by using one or more program design language or any combination. The program design language includes, but is not limited to, object oriented program design language such as Java, Smalltalk and C++, and further includes conventional process-type program design language such as “C” or similar program design language. The program code may be completely or partially executed on a user computer, performed as an independent software packet, partially executed on the user computer and partially executed on a remote computer, or completely executed on the remote computer or a server. In a case of involving the remote computer, the remote computer may connect to the user computer via any type of network such as a local area network (LAN) and a wide area network (WAN). Alternatively, the remote computer may connect to an external computer (such as achieving internet connection by services provided by the internet network service provider).

The flowchart and block diagrams in the drawings illustrate the architecture, functionality and operation of possible implementations of systems, methods and computer program products according to various embodiments of the present disclosure. In this regard, each block in the flowchart or block diagrams may represent a block, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems which perform the specified functions or acts, or combinations of special purpose hardware and computer instructions.

Related units for describing the embodiments of the present disclosure may be implemented in the form of software, or may be implemented in the form of hardware. In certain circumstances, the names of units/blocks do not formulate limitation to the units per se. For example, the first obtaining unit may be described as “a unit for obtaining at least two Internet Protocol Addresses.”

The functions described above may be performed, at least in part, by one or more hardware logic components. For example, without limitation, exemplary types of hardware logic components that may be used include: Field Programmable Gate Arrays (FPGAs), Application Specific Integrated Circuits (ASICs), Application Specific Standard Products (ASSPs), Systems on Chip (SOCs), Complex Programmable Logic Devices (CPLDs), and the like.

In the context of this disclosure, a machine-readable medium may be a tangible medium that can contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of a computer-readable storage medium would include an electrical connection based on one or more wires, a portable computer diskette, a hard disk, an RAM, an ROM, an EPROM or flash memory, an optical fiber, a CD-ROM, an optical storage device, a magnetic storage device, or any suitable combination of the foregoing.

According to one or more embodiments of the present disclosure, [Example I] provides an image processing method comprising:
obtaining an image;
receiving a template triggering operation for the image and displaying at least one template each comprising at least one template element; and
receiving a template selection operation for the template, and displaying a target effect image by applying a selected template to the image, wherein a target display mode of at least part of template elements is different from a default display mode of the at least part of the template elements.

According to one or more embodiments of the present disclosure, [Example II] provides the method of Example I, further comprising:
for the selected template, determining an element of the at least one template element corresponding to the template, and adjusting a default display mode of the element; and
in a case that a display position of the element of the template has been adjusted, displaying the target effect image by applying the adjusted template to the image.

According to one or more embodiments of the present disclosure, [Example III] provides the method of Example II, further comprising:
for each element, in a case that the image comprises a target interactive subject corresponding to the element, adjusting the default display mode of the element according to a preset interactive mode corresponding to the element to apply the element to the target interactive subject.

According to one or more embodiments of the present disclosure, [Example IV] provides the method of Example II, further comprising:
for each element, in a case that the element is a title element, determining at least one set of candidate display modes corresponding to the element; and
determining, using a first model and the candidate display modes, a target display mode of the element, and adjusting the element based on the target display mode and the default display mode of the element.

According to one or more embodiments of the present disclosure, [Example V] provides the method of Example II, further comprising:
for each element, determining an associated display object of the element; and
determining overlapping information between the element and the associated display object, and adjusting, based on the overlapping information, the default display mode of the element.

According to one or more embodiments of the present disclosure, [Example VI] provides the method of Example V, further comprising:
obtaining contour information or a mask image of the element, and determining, based on the contour information or the mask image, whether there is an overlapping area between the element and the associated display object.

According to one or more embodiments of the present disclosure, [Example VII] provides the method of Example VI, further comprising
in a case that there is an overlapping area between the element and the associated display object, adjusting the default display mode of the element to cause the overlapping area between the element and the associated display object disappear.

According to one or more embodiments of the present disclosure, [Example VIII] provides the method of Example VII, further comprising:
determining, based on display positions of the element and the associated display object, a first direction vector, and adjusting, based on the first direction vector, the default display mode of the element to cause the overlapping area between the element and the associated display object disappear.

According to one or more embodiments of the present disclosure, [Example IX] provides the method of Example II, further comprising:
adjusting, based on an element category corresponding to each element in the template and an adjustment priority corresponding to the element category, the default display mode of the element.

According to one or more embodiments of the present disclosure, [Example X] provides the method of Example IX, where element categories comprise an interactive element, a title element or others, and wherein adjustment priorities corresponding to the element categories, from high to low, are as follows: the interactive element, the title element, and others.

According to one or more embodiments of the present disclosure, [Example XI] provides the method of Example I, further comprising:
determining a target display area in the image, determining, based on the target display area, a target image, and displaying the target effect image by applying the selected template to the target image.

According to one or more embodiments of the present disclosure, [Example XII] provides the method of Example XI, where determining the target display area in the image comprises at least one of the following:
determining salient information in the image, and using an image area corresponding to the salient information as the target display area;
determining an environmental target subject in the image, and using an image area corresponding to the environmental target subject as the target display area; or
determining, based on a second model, the target display area in the image.

According to one or more embodiments of the present disclosure, [Example XIII] provides an image processing apparatus comprising:
an image obtaining module configured to obtain an image;
a template displaying module configured to receive a template triggering operation for the image, and display at least one template each comprising at least one template element; and
an image displaying module configured to receive a template selection operation for the template, and display a target effect image by applying a selected template to the image, wherein a target display mode of at least part of the template elements is different from a default display mode of the at least part of the template elements.

Further, while operations are depicted in a particular order, this should not be understood as requiring that such operations be performed in the particular order shown or in sequential order. In certain circumstances, multitasking and parallel processing may be advantageous. Likewise, while several specific implementation details are contained in the above discussions, these should not be construed as limitations on the scope of the present disclosure, but rather as descriptions of features that may be specific to particular implementations. Certain features that are described in the context of separate embodiments may also be implemented in combination in a single embodiment. Conversely, various features that are described in the context of a single embodiment may also be implemented in multiple embodiments separately or in any suitable sub-combination.

1. An image processing method comprising:
obtaining an image;
receiving a template triggering operation for the image and displaying at least one template each comprising at least one template element; and
receiving a template selection operation for the template, and displaying a target effect image by applying a selected template to the image, wherein a target display mode of at least part of template elements is different from a default display mode of the at least part of the template elements.

2. The image processing method of claim 1, wherein displaying the target effect image by applying the selected template to the image comprises:
for the selected template, determining an element of the at least one template element corresponding to the template, and adjusting a default display mode of the element; and
in a case that a display position of the element of the template has been adjusted, displaying the target effect image by applying the adjusted template to the image.

3. The image processing method of claim 2, wherein adjusting the default display mode of the element comprises:
for each element, in a case that the image comprises a target interaction subject corresponding to the element, adjusting the default display mode of the element according to a preset interaction mode corresponding to the element to apply the element to the target interaction subject.

4. The image processing method of claim 2, where adjusting the default display mode of the element comprises:
for each element, in a case that the element is a title element, determining at least one set of candidate display modes corresponding to the element; and
determining, using a first model and the candidate display modes, a target display mode of the element, and adjusting the element based on the target display mode and the default display mode of the element.

5. The image processing method of claim 2, wherein adjusting the default display mode of the element comprises:
for each element, determining an associated display object of the element; and
determining overlapping information between the element and the associated display object, and adjusting, based on the overlapping information, the default display mode of the element.

6. The image processing method of claim 5, wherein determining the overlapping information between the element and the associated display object comprises:
obtaining contour information or a mask image of the element, and determining, based on the contour information or the mask image, whether there is an overlapping area between the element and the associated display object.

7. The image processing method of claim 6, wherein adjusting, based on the overlapping information, the default display mode of the element comprises:
in a case that there is the overlapping area between the element and the associated display object, adjusting the default display mode of the element to cause the overlapping area between the element and the associated display object disappear.

8. The image processing method of claim 7, wherein adjusting the default display mode of the element to cause the overlapping area between the element and the associated display object disappear comprises:
determining, based on display positions of the element and the associated display object, a first direction vector, and adjusting, based on the first direction vector, the default display mode of the element to cause the overlapping area between the element and the associated display object disappear.

9. The image processing method of claim 2, wherein adjusting the default display mode of the element comprises:
adjusting, based on an element category corresponding to each element in the template and an adjustment priority corresponding to the element category, the default display mode of the element.

10. The image processing method of claim 9, wherein element categories comprise an interaction element, a title element or others, and wherein adjustment priorities corresponding to the element categories, from high to low, are as follows: the interactive element, the title element, and others.

11. The image processing method of claim 1, wherein displaying the target effect image by applying the selected template to the image comprises:
determining a target display area in the image, determining, based on the target display area, a target image, and displaying the target effect image by applying the selected template to the target image.

12. The image processing method of claim 11, wherein determining the target display area in the image comprises at least one of the following:
determining salient information in the image, and using an image area corresponding to the salient information as the target display area; or
determining an environmental target subject in the image, and using an image area corresponding to the environmental target subject as the target display area.

13. (canceled)

14. An electronic device comprising:
at least one processor; and
a memory configured to store at least one program;
wherein the at least one program, when executed by the at least one processor, causes the at least one processor to implement an image processing method comprising:
obtaining an image;
receiving a template triggering operation for the image and displaying at least one template each comprising at least one template element; and
receiving a template selection operation for the template, and displaying a target effect image by applying a selected template to the image, wherein a target display mode of at least part of template elements is different from a default display mode of the at least part of the template elements.

15. A non-transitory storage medium comprising computer executable instructions used to execute an image processing method comprising:
obtaining an image;
receiving a template triggering operation for the image and displaying at least one template each comprising at least one template element; and
receiving a template selection operation for the template, and displaying a target effect image by applying a selected template to the image, wherein a target display mode of at least part of template elements is different from a default display mode of the at least part of the template elements.

16. (canceled)

17. The electronic device of claim 14, wherein displaying the target effect image by applying the selected template to the image comprises:
for the selected template, determining an element of the at least one template element corresponding to the template, and adjusting a default display mode of the element; and
in a case that a display position of the element of the template has been adjusted, displaying the target effect image by applying the adjusted template to the image.

18. The electronic device of claim 17, wherein adjusting the default display mode of the element comprises:
for each element, in a case that the image comprises a target interaction subject corresponding to the element, adjusting the default display mode of the element according to a preset interaction mode corresponding to the element to apply the element to the target interaction subject.

19. The electronic device of claim 17, where adjusting the default display mode of the element comprises:
for each element, in a case that the element is a title element, determining at least one set of candidate display modes corresponding to the element; and
determining, using a first model and the candidate display modes, a target display mode of the element, and adjusting the element based on the target display mode and the default display mode of the element.

20. The electronic device method of claim 17, wherein adjusting the default display mode of the element comprises:
for each element, determining an associated display object of the element; and
determining overlapping information between the element and the associated display object, and adjusting, based on the overlapping information, the default display mode of the element.

21. The electronic device of claim 20, wherein determining the overlapping information between the element and the associated display object comprises:
obtaining contour information or a mask image of the element, and determining, based on the contour information or the mask image, whether there is an overlapping area between the element and the associated display object.

22. The electronic device of claim 21, wherein adjusting, based on the overlapping information, the default display mode of the element comprises:
in a case that there is the overlapping area between the element and the associated display object, adjusting the default display mode of the element to cause the overlapping area between the element and the associated display object disappear.
